(19) United States
(12) Patent Application Publication
(10) Pub. No.: US 2014/0240841 A1
(43) Pub. Date: Aug. 28, 2014

(54) Telescopic Sight

(71) Applicants: Asia Optical International Ltd., Tortola (GB); Sintai Optical (Shenzhen) Co., Ltd., Shenzhen City (CN)

(72) Inventors: Tung-Yao Cheng, Taichung (TW); Tsung-Mou Tsai, Taichung (TW)

(73) Assignees: Asia Optical International Ltd., Tortola (GB); Sintai Optical (Shenzhen) Co., Ltd., Shenzhen City (CN)

(21) Appl. No.: 14/161,719

(22) Filed: Jan. 23, 2014

(30) Foreign Application Priority Data
Feb. 26, 2013 (TW) 102106639

(51) Int. Cl. G02B 5/20

(52) U.S. Cl. CPC G02B 5/20
USPC 359/612

(57) ABSTRACT

A telescopic sight includes a main body, a positioning-adjustable member, and a sunshade hood. The main body includes a lens chamber and an enclosure, and the enclosure covers the lens chamber and includes at least one slot. The positioning-adjustable member is movably disposed in the slot. The sunshade hood includes at least one hole corresponding to the positioning-adjustable member, and the positioning-adjustable member is partially disposed in the hole.

### BACKGROUND OF THE INVENTION

1. Field of the Invention

The invention relates to a telescopic sight having a sunshade hood, and more particularly to a telescopic sight having a positioning-adjustable sunshade hood.

2. Description of the Related Art

A typical telescopic sight must be adaptable to various environments, and light receiving ability of the telescopic sight directly affects convenience of operation. Light from outer environment, such as sun light, often influences the utility of the telescopic sight, and thus a sunshade hood provides a solution for this problem. FIG. 1 depicts a conventional telescopic sight 10 provided with a sunshade hood. The telescopic sight 10 includes a main body 11, a sunshade hood 12 and a decoration ring 13. The decoration ring 13 connects the main body 11 and the sunshade hood 12, and the sunshade hood 12 engages with the decoration ring by threads. Although such structure is capable of sustaining impact force caused by shooting rifle, the sunshade hood is an accessory of the telescopic sight and has complicated steps for assembly or disassembly, which causes inconvenience in transport and operation.

### BRIEF SUMMARY OF THE INVENTION

The invention provides a telescopic sight provided with a positioning-adjustable sunshade hood. The telescopic sight in accordance with an exemplary embodiment of the invention includes a main body, a positioning-adjustable member, and a sunshade hood. The main body includes a lens chamber and an enclosure which covers the lens chamber and has at least one slot. The positioning-adjustable member is movably disposed in the slot. The sunshade hood includes at least one hole corresponding to the positioning-adjustable member, wherein the positioning-adjustable member is partially disposed in the hole.

In another exemplary embodiment, the positioning-adjustable member includes a protrusion and a pressing section movably disposed in the slot and partially inserted in the hole.

In yet another exemplary embodiment, the sunshade hood is positioned relative to the main body by abutment or pressing of the pressing section on an inner wall of the slot.

In another exemplary embodiment, the laser receiver includes an avalanche photo diode (APD).

In yet another exemplary embodiment, the positioning-adjustable member further includes a retaining ring engaging with the pressing section and a spring propped against the retaining ring and an inner wall of the sunshade hood.

In another exemplary embodiment, the enclosure has a plurality of slots receiving the pressing section.

In yet another exemplary embodiment, the main body further includes a stop ring connected to the enclosure to prevent the sunshade hood from falling off.

The telescopic sight in another exemplary embodiment includes a main body and a sunshade unit. The main body includes a lens chamber and an enclosure which covers the lens chamber and has at least one slot. The sunshade unit includes a pressing section movably disposed in the slot and capable of being positioned in the slot, wherein the sunshade unit is positioned relative to the main body by abutment or pressing of the pressing section on an inner wall of the slot.

In yet another exemplary embodiment, the main body further includes a stop ring connected to the enclosure to prevent the sunshade hood from falling off.

In another exemplary embodiment, the slot has a plurality of positioning holes receiving the pressing section to position the sunshade unit.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional telescopic sight provided with a sunshade hood;

FIG. 2A is a perspective view of an embodiment of a telescopic sight of the invention, wherein a sunshade hood of the telescopic sight is in a retracted position;

FIG. 2B is a perspective view of an embodiment of a telescopic sight of the invention, wherein a sunshade hood of the telescopic sight is in a stretched position;

FIG. 3 is an exploded view of an embodiment of a telescopic sight of the invention;

FIG. 4 is a cross sectional view of an embodiment of a telescopic sight of the invention;

FIG. 5 is an exploded view of an embodiment of an positioning-adjustable member of the invention;

FIGS. 6A & 6B depict operation of a positioning-adjustable member of the invention; and

FIG. 7 is another perspective view of an embodiment of a telescopic sight of the invention.

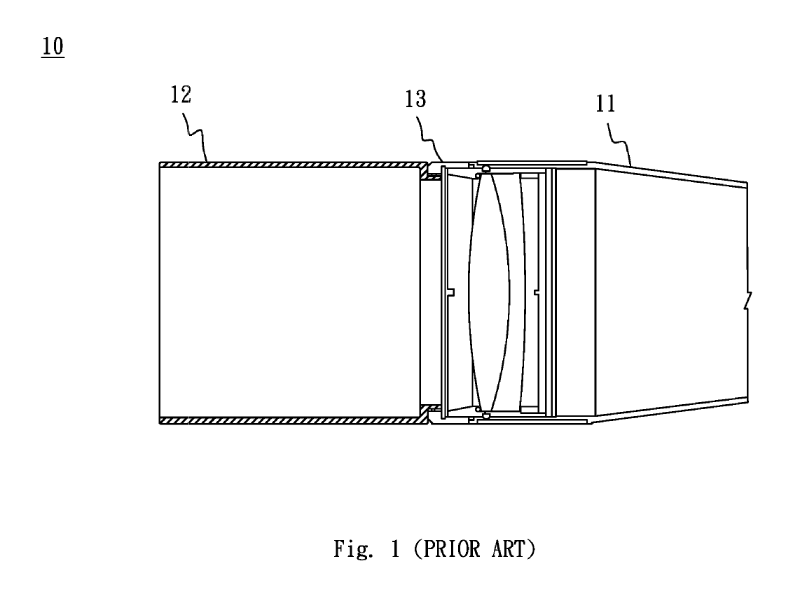

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

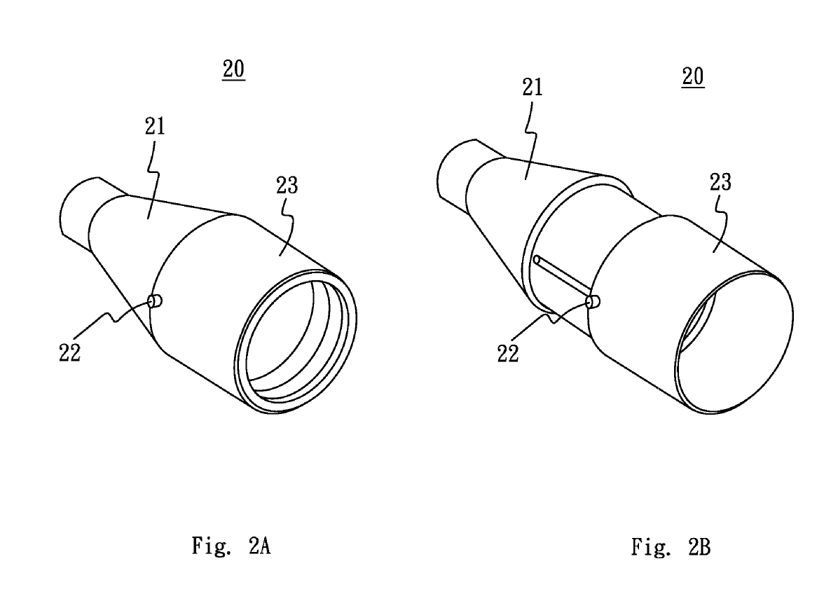

Referring to FIGS. 2A and 2B, a telescopic sight 20 provided with a sunshade hood 23 of the invention is presented. In FIG. 2A, the sunshade hood 23 is retracted to a main body 21. In FIG. 2B, the sunshade hood 23 is stretched from the main body 21 to increase light shading effect.

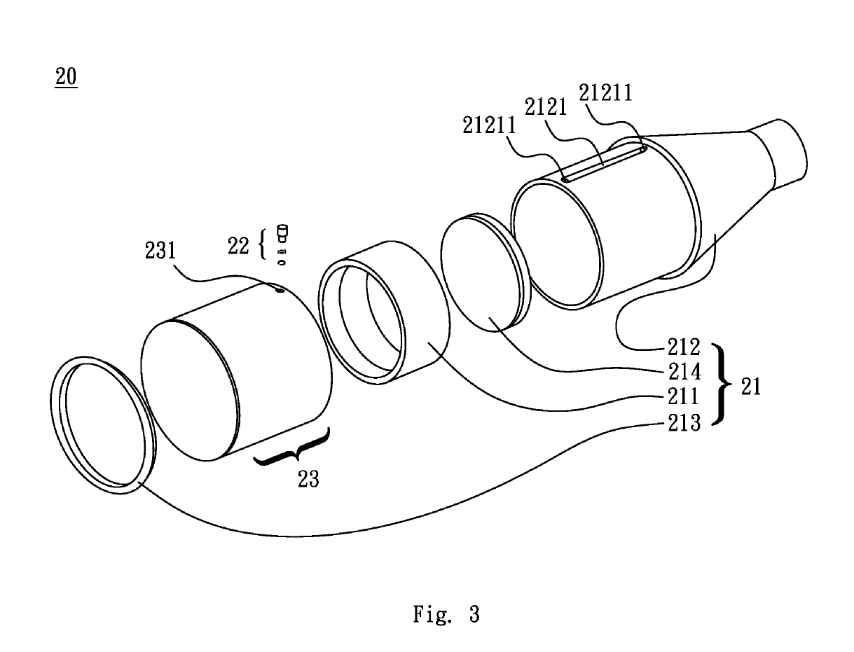

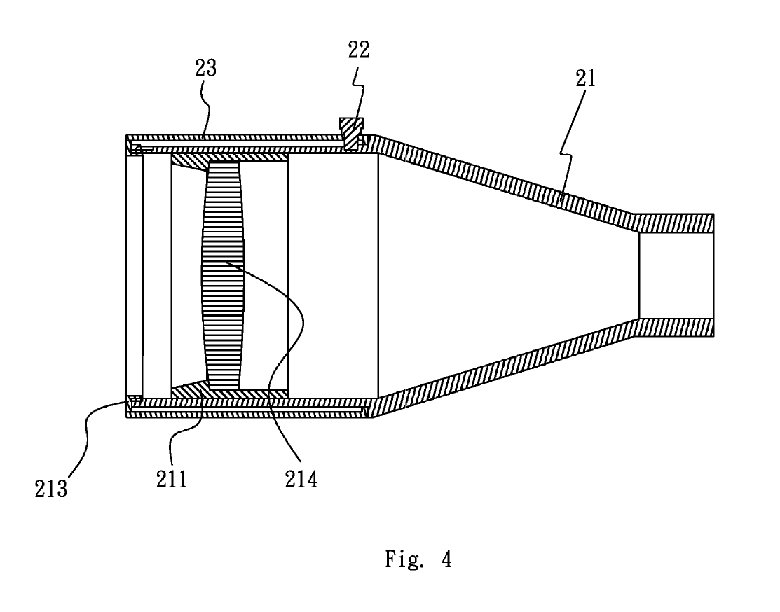

Referring to FIGS. 3 and 4, a telescopic sight 20 includes a main body 21, at least one positioning-adjustable member 22 and a sunshade hood 23, which are described in the following paragraphs.

The main body 21 includes a stop ring 213, a lens chamber 211, a lens 214 and an enclosure 212. The lens 214 is fixed in the lens chamber 211, and the enclosure 212 encloses the lens chamber 211 and has at least one slot 2121. The number of the slot 2121, not limited as shown in FIGS. 2A-7, depends on requirements in various applications and may be increased in certain conditions such as in dynamic balance. The stop ring 213 is connected to an objective end of the enclosure 212 to prevent the sunshade hood 23 from falling off. When the sunshade hood 23 is moved from the retracted position outwards, the stop ring 213 stops the movement of the sunshade hood 23 and prevents the sunshade hood 23 from falling off.

The sunshade hood 23 has at least one hole 231 corresponding to the positioning-adjustable member 22.

The positioning-adjustable member 22 is moved through the hole 231 and presses or abuts an inner wall of the slot 2121 to position the sunshade hood 23 relative to the main body 21. The slot 2121 includes a plurality of positioning holes 21211 with which the positioning-adjustable member 22 can engage firmly to position the sunshade hood 23. However, the number of the positioning holes 21211, not limited as shown in FIGS. 2A-7, depends on various requirements such as light shading effects.

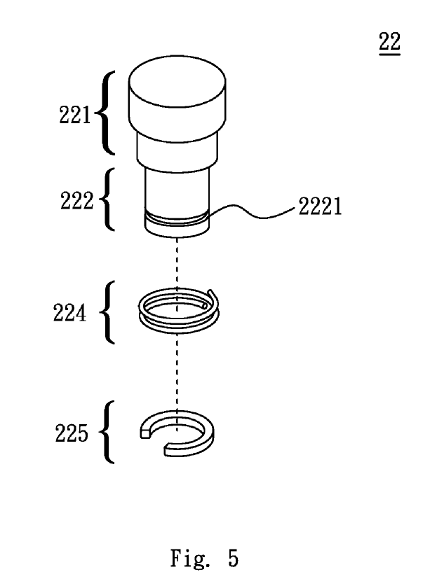

Referring to FIG. 5, the positioning-adjustable member 22 includes a protrusion 221, a pressing section 222, a spring 224 and a retaining ring 225. The pressing section 222 is movably disposed in the slot 2121. The abutment or pressing of the pressing section 222 on the inner wall of the slot 2121 is performed by pushing, pulling or rotating the protrusion 221. The positioning-adjustable member 22 is joined to the sunshade hood 23 by the spring 224 and the retaining ring 225. The retaining ring 225 engages with a groove 2221 formed on the pressing section 222. The spring 224 is propped against the retaining ring 225 and the inner wall of the sunshade hood 23.

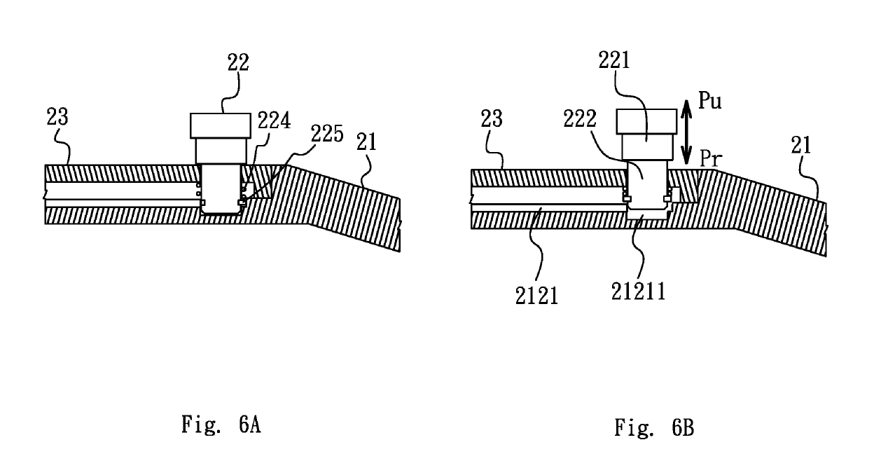

FIGS. 6A and 6B depict the pressing section 222 of the positioning-adjustable member 22 entering the positioning hole 21211 and leaving the positioning hole 21211 respectively. When the pressing section 222 enters and abuts the positioning hole 21211, the sunshade hood 23 is positioned relative to the main body 21. When the pressing section 222 leaves the positioning hole 21211, the positioning-adjustable member 22 moves in a direction Pu (a user pulls the protrusion 221) so that the sunshade hood 23 becomes slidable and capable of moving from the retracted position. When the positioning-adjustable member 22 is released, the positioning-adjustable member 22 is moved in a direction Pr by the restoring force of the spring 224, and the pressing section 222 abuts another positioning hole 21211 to position the sunshade hood 23 relative to the main body 21.

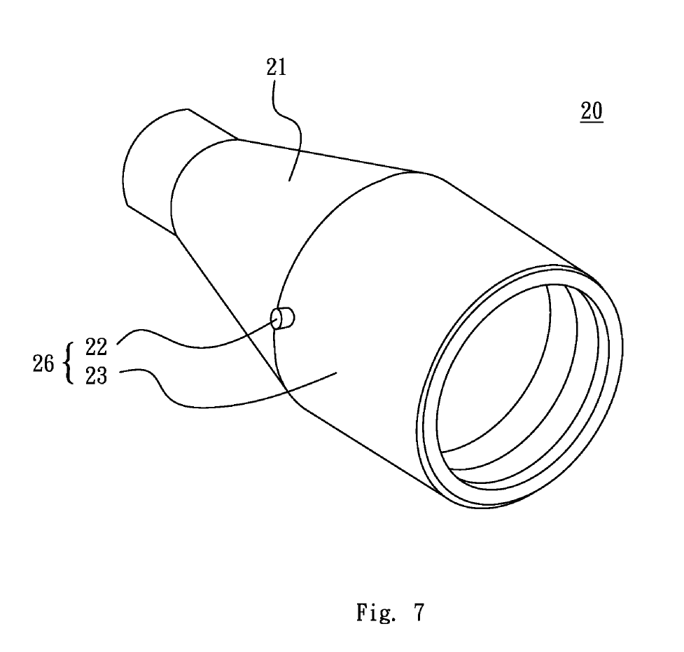

Referring to FIG. 7, the telescopic sight 20 of the invention includes a main body 21 and a sunshade unit 26. The sunshade unit 26 includes a sunshade hood 23 and a positioning-adjustable member 22. The structure of the telescopic sight 20 is the same as the described embodiment.

While the invention has been described by way of example and in terms of preferred embodiment, it is to be understood that the invention is not limited thereto. To the contrary, it is intended to cover various modifications and similar arrangements (as would be apparent to those skilled in the art). For example, an auxiliary ring is added, which has a screw groove engaging with the protrusion to enclosing the main body and sunshade hood so that the auxiliary ring controls the movement of the sunshade hood. For another example, the positioning hole is regulated according to practical requirements. For yet another example, a recess with a positioning function is provided. For another example, a recess is formed on the inner walls of the slot. Other fixing structure for avoiding an accidentally movement of the sunshade hood due to external impacts (shooting, lying prone, etc.) can be additionally used in the invention. Therefore, the scope of the appended claims should be accorded the broadest interpretation so as to encompass all such modifications and similar arrangements.

What is claimed is:

1. A telescopic sight, comprising:
a main body comprising a lens chamber and an enclosure which covers the lens chamber and has at least one slot;
a positioning-adjustable member movably disposed in the slot; and
a sunshade hood comprising at least one hole corresponding to the positioning-adjustable member, wherein the positioning-adjustable member is partially disposed in the hole.

2. The telescopic sight as claimed in claim 1, wherein the positioning-adjustable member comprises a protrusion and a pressing section movably disposed in the slot and partially inserted in the hole.

3. The telescopic sight as claimed in claim 2, wherein the sunshade hood is positioned relative to the main body by abutment or pressing of the pressing section on an inner wall of the slot.

4. The telescopic sight as claimed in claim 2, wherein the pressing section is abutted or pressed on an inner wall of the slot by pushing, pulling or rotating the protrusion.

5. The telescopic sight as claimed in claim 2, wherein the positioning-adjustable member further comprises an retaining ring engaging with the pressing section and a spring propped against the retaining ring and an inner wall of the sunshade hood.

6. The telescopic sight as claimed in claim 2, wherein the enclosure has a plurality of slots receiving the pressing section.

7. The telescopic sight as claimed in claim 1, wherein the main body further comprises a stop ring connected to the enclosure to prevent the sunshade hood from falling off.

8. A telescopic sight, comprising:
a main body comprising a lens chamber and an enclosure which covers the lens chamber and has at least one slot; and
a sunshade unit comprising a pressing section movably disposed in the slot and capable of being positioned in the slot, wherein the sunshade unit is positioned relative to the main body by abutment or pressing of the pressing section on an inner wall of the slot.

9. The telescopic sight as claimed in claim 8, wherein the main body further comprises a stop ring connected to the enclosure to prevent the sunshade unit from falling off.

10. The telescopic sight as claimed in claim 8, wherein the slot has a plurality of positioning holes receiving the pressing section to position the sunshade unit.
